(19) United States
(12) Patent Application Publication
(10) Pub. No.: US 2026/0093035 A1
(43) Pub. Date: Apr. 2, 2026

(54) ULTRASONIC SENSORS WITH ADAPTIVE DATA COMPRESSION

(71) Applicant: SEMICONDUCTOR COMPONENTS INDUSTRIES, LLC, Scottsdale, AZ (US)

(72) Inventor: Marek HUSTAVA, Bratislava (SK)

(73) Assignee: SEMICONDUCTOR COMPONENTS INDUSTRIES, LLC, Scottsdale, AZ (US)

(21) Appl. No.: 19/091,748

(22) Filed: Mar. 26, 2025

Related U.S. Application Data
(60) Provisional application No. 63/700,271, filed on Sep. 27, 2024.

(51) Int. Cl. G01S 15/931; B06B 1/02

(52) U.S. Cl. CPC G01S 15/931; B06B 1/0215; B06B 2201/55

(57) ABSTRACT

Ultrasonic sensors, sensor controllers, and sensing methods may employ adaptive data compression to improve important aspects of measurement signal fidelity while retaining the main benefits of data compression. One illustrative sensor includes: a piezoelectric transducer; and a sensor controller. The sensor controller includes: a receiver coupled to an ultrasonic transducer to obtain a receive signal having one or more reflections of an acoustic burst within a measurement interval associated with the acoustic burst; a correlator configured to produce an output signal having a peak for each of the one or more reflections; and a compressor configured to determine a digital representation of the output signal for communication via a bus using at least one encoding parameter that varies within the measurement interval.

### CROSS-REFERENCE TO RELATED APPLICATIONS

The present application claims benefit of provisional U.S. application 63/700,271, filed 2024 Sep. 27 and titled “Ultrasonic sensor with adaptive sampling and adaptive data interface” by inventor M. Hustava. The foregoing application is hereby incorporated herein by reference.

### BACKGROUND

Modern automobiles are equipped with an impressive number and variety of sensors. For example, cars are now routinely equipped with arrays of ultrasonic sensors to monitor distances between the car and any nearby persons, pets, vehicles, or obstacles. Due to environmental noise and safety concerns, each of the sensors may be asked to provide tens of measurements each second, each measurement requiring analysis of hundreds of multi-bit signal samples for each channel. When the analysis for multiple such sensors is performed by a so-called fusion processor that collects the various sensor data streams to enable cross-sensor and combined sensor measurements for enhanced sensing accuracy and reliability, the required communication bandwidth becomes somewhat challenging to provide in a cost-effective fashion while complying with industry-standard limitations on electromagnetic emissions.

Certain proposed solutions employ lossy data compression to reduce the number of bits conveyed via the communication bus. Such compression entails a certain loss of measurement signal fidelity, which may adversely impact the fusion processor's obstacle detection accuracy. Yet without such compression, existing automotive networks would need to be fully redesigned with associated impacts on their cost and performance.

### SUMMARY

Accordingly, there are disclosed ultrasonic sensors, sensor controllers, and sensing methods that employ adaptive data compression to improve important aspects of measurement signal fidelity while retaining the main benefits of data compression. One illustrative sensor includes: a piezoelectric transducer; and a sensor controller. The sensor controller includes: a receiver coupled to an ultrasonic transducer to obtain a receive signal having one or more reflections of an acoustic burst within a measurement interval associated with the acoustic burst; a correlator configured to produce an output signal having a peak for each of the one or more reflections; and a compressor configured to determine a digital representation of the output signal for communication via a bus using at least one encoding parameter that varies within the measurement interval.

One illustrative method includes: obtaining a receive signal having one or more reflections of an acoustic burst within a measurement interval associated with the acoustic burst; applying a correlation filter to produce an output signal having a peak for each of the one or more reflections; and determining a digital representation of the output signal using at least one encoding parameter that varies within the measurement interval.

Each of the foregoing examples can be employed individually or in conjunction and may include one or more of the following features in any suitable combination: 1. the at least one encoding parameter is one of: a signal decimation rate, a bit resolution, a quantization threshold, and a signal type. 2. the signal type is selectable from a set that includes at least: output signal magnitude; and output signal value expressed in terms of in-phase and quadrature components or in terms of magnitude and phase. 3. the at least one encoding parameter varies based on elapsed time within the measurement interval. 4. the at least one encoding parameter is the signal decimation rate. 5. the signal decimation rate increases during the measurement interval. 6. the at least one encoding parameter is the bit resolution. 7. the bit resolution decreases during the measurement interval. 8. the at least one encoding parameter is the signal type. 9. the signal type is initially the output signal value and switches to output signal magnitude during the measurement interval. 10. the compressor identifies a corresponding output signal segment for each of said peaks. 11. the at least one encoding parameter varies based on content of the output signal segment. 12. the encoding parameter is a higher signal decimation rate by default, which changes to a lower signal decimation rate when the output signal segment includes a phase shift or an interpolation error above a predetermined threshold. 13. the encoding parameter is the signal type, defaulting to the output signal magnitude and changing to the output signal value when the output signal segment includes a phase shift or an interpolation error above a predetermined threshold. 14. the encoding parameter is a lower bit resolution by default, which changes to a higher bit resolution when the output signal segment includes a marginal signal below a lowest quantization threshold. 15. the encoding parameter is a standard lowest quantization threshold by default, which changes to a noise threshold when the output signal segment includes a marginal signal below the standard lowest quantization threshold. 16. the measurement interval includes at least a noise monitoring period and an echo detection period. 17. the at least one encoding parameter is a signal decimation rate that switches between 1:1 during the noise monitoring period and at least 2:1 for at least part of the echo detection period.

### BRIEF DESCRIPTION OF THE DRAWINGS

FIG. 1 is an overhead view of an illustrative vehicle equipped with driving-assist sensors.

FIG. 2 is a block diagram of an illustrative driver assist system.

FIG. 3 is a circuit schematic of an illustrative ultrasonic sensor.

FIG. 4 is a block diagram of an illustrative ultrasonic sensor.

FIG. 5 is a graph comparing signals useful for echo detection.

FIG. 6 is a block diagram for producing the output magnitude signal of FIG. 5.

FIG. 7A is a graph of an illustrative correlation magnitude for overlapping echoes.

FIG. 7B is a graph of an illustrative curve interpolated from a decimated signal.

FIG. 7C is a graph of an illustrative curve interpolated from an adaptively compressed data stream.

FIG. 8A is a graph of an illustrative correlation magnitude with a marginal signal.

FIG. 8B is a graph of an illustrative curve interpolated from a decimated signal.

FIG. 8C is a graph of an illustrative curve interpolated from an adaptively compressed data stream.

FIG. 8D is a graph of an illustrative curve interpolated from an alternative adaptively compressed data stream.

FIG. 9 is a flow diagram of an illustrative sensing method.

FIG. 10 is a diagram of an illustrative digital representation for a compressed output signal segment.

### DETAILED DESCRIPTION

The drawings and following description do not limit the disclosure, but on the contrary, they provide the foundation for one of ordinary skill in the art to understand all modifications, equivalents, and alternatives falling within the scope of the claim language.

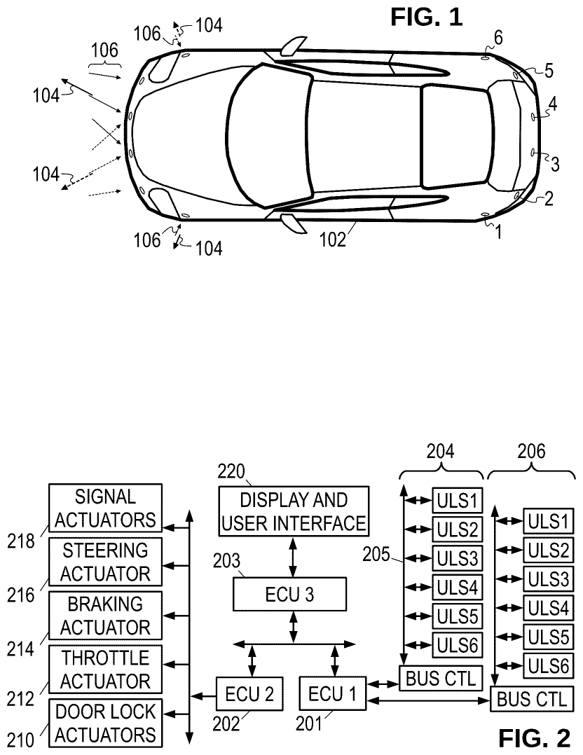

As an illustrative usage context, FIG. 1 shows a vehicle 102 equipped with a set of ultrasonic sensors 1-6 on the rear side and a similar set on the front side. The ultrasonic sensors are transceivers, meaning that each sensor can transmit and receive bursts of ultrasonic sound. Emitted bursts propagate outward from the vehicle until they encounter and reflect from an object or some other form of acoustic impedance mismatch. The reflected bursts return to the vehicle as “echoes” of the emitted bursts. The times between the emitted bursts and received echoes are indicative of the distances to the reflection points. The number and configuration of sensors in the sensor arrangement varies.

In the illustrated arrangement, sensor 1 is the left side sensor, sensor 2 is the left intermediate sensor, sensor 3 is the left center sensor, sensor 4 is the right center sensor, sensor 5 is the right intermediate sensor, and sensor 6 is the right-side sensor. From the front-side sensor array, arrows 104 represent the acoustic bursts emitted by sensors 1, 3, 4, and 6. It is contemplated that the bursts are emitted concurrently, with sensors 1 and 4 transmitting in the low channel and sensors 3 and 6 transmitting in the high channel. The low channel and high channel may represent nonoverlapping frequency bands that fall within the band of frequencies detectable by the ultrasonic transducers.

Arrows 106 represent the reflections of the acoustic bursts returning to the sensor array. Sensor 1 may be configured to detect direct reflections of its transmitted acoustic bursts. Sensor 2 may be configured to detect indirect reflections of the acoustic bursts transmitted by sensor 3. Sensor 3 may be configured to detect direct reflections of its transmitted acoustic bursts and indirect reflections of acoustic bursts transmitted by sensor 4. Sensor 4 may be configured to detect direct reflections of its acoustic bursts and indirect reflections of acoustic bursts from sensor 3. Sensor 5 may be configured to detect indirect reflections of acoustic bursts from sensor 4. Sensor 6 may be configured to detect direct reflections of its acoustic bursts. In all, each sensor array may be monitoring eight propagation paths, enabling the fusion processor to detect and measure distances to objects in the various detection zones, potentially using the sensors for individual measurements as well as cooperative (e.g., triangulation, multi-receiver) measurements.

FIG. 2 is a block diagram of an illustrative automated driver assist system. The illustrative system includes a set of interconnected ECUs (electronic control units) 201-203 organized in a hierarchical bus topology. Of course, other topologies including serial, parallel, star, and ring topologies, are also suitable and contemplated for use in accordance with the principles disclosed herein. Though multiple ECUs are shown and described here, in some cases it may be preferred to implement the various functions with a single ECU.

A first ECU 201, also referred to herein as a fusion processor, is coupled to bus controllers for two arrays of ultrasonic sensors 204, 206 to detect and monitor objects around the vehicle. An automotive serial bus 205 may be used for the sensor arrays such as, e.g., those provided in the DSI3, LIN, and CAN standards. To provide automated parking or other advanced features, a second ECU 202 may connect to a set of actuators such as door lock actuators 210, a throttle actuator 212, a braking actuator 214, a steering actuator 216, and turn-signal actuators 218. The third ECU 203 may couple to a user-interactive interface 220 to accept user input and provide a display of the various measurements and system status. Using the interface, sensors, and actuators, ECUs 201-203 may provide automated parking, assisted parking, lane-change assistance, obstacle and blind-spot detection, and other desirable features.

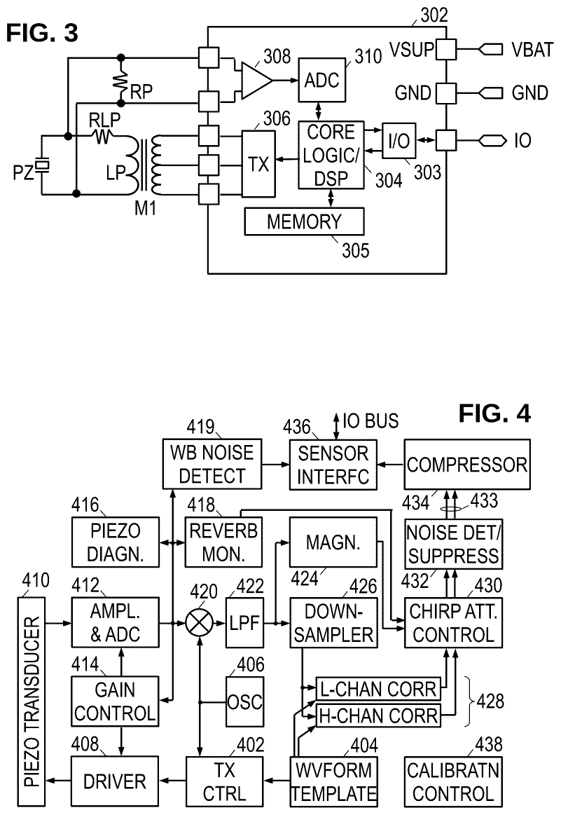

One potential sensor configuration is now described with reference to FIG. 3, which shows a three-terminal configuration with two terminals for power and one terminal for I/O. Contemplated communication and power supply techniques include those provided in the DSI3, LIN, and CAN standards, would also be suitable and are contemplated for use in accordance with the principles disclosed herein. Besides the two power terminals (Vbat and GND) shown in the embodiment of FIG. 3, each of the illustrative ultrasonic sensors is only connected to the bus controller by a single input/output (“I/O” or “IO”) line. The I/O line may be biased to the supply voltage (the “de-asserted” state) by a pull-up resistor when it is not actively driven low (the “asserted” state) by the bus controller or by the sensor controller 302. The communication protocol is designed to have only one of the two controllers asserting the I/O line at any given time.

The sensor controller 302 includes an I/O interface 303 that, when placed in a recessive mode, monitors the I/O line for assertion by the bus controller and, when placed in a dominant mode, drives the state of the I/O line. The bus controller communicates a command to the sensor by asserting the I/O line to convey a command word or a frame initiation pulse. The sensor controller 302 includes a core logic 304 that operates in accordance with firmware and parameters stored in nonvolatile memory 305 to parse received commands and carry out the appropriate operations, including the transmission of ultrasonic bursts and reception of reflection signals. To transmit an ultrasonic burst, the core logic 304 is coupled to a transmitter 306 which, with a suitably modulated local oscillator signal, drives a set of transmit terminals on the sensor controller 302. The transmitter terminals may be coupled via a transformer M1 to a piezoelectric element PZ. The transformer windings have an inherent inductance LP and resistance RLP. The transformer M1 steps up the voltage from the sensor controller (e.g., 12 volts) to a suitable level for driving the piezoelectric element (e.g., tens of volts). A parallel resistor RP may be provided for damping residual vibration of the piezoelectric element.

As used herein, the term “piezoelectric transducer” includes not only the piezoelectric element, but also the supporting circuit elements for tuning, driving, and sensing, the piezoelectric element. However, the use of the term “piezoelectric transducer” does not necessarily require the presence of any supporting circuit elements, as a piezoelectric element may be employed alone without such supporting elements.

In various implementations, use is made of chirp-modulated signals, for instance, a linear frequency modulated (“LFM”) chirp. A chirp is a pulse that changes frequency during transmission. An up-chirp is a signal pulse that increases in frequency during transmission, and a down-chirp is a signal pulse that decreases in frequency during transmission. For clarity, the examples used herein will consider a linear increase or decrease, but in various contemplated alternative implementations the increase or decrease is not linear. The echo of a chirp may be compressed in a correlator without introducing much or any correlation noise. As such, peak detection of the echo is eased without decreasing time resolution. Additionally, LFM chirps withstand Doppler frequency shift without, or with a minimum of, any increase in correlation noise. LFM chirps can be used as transmit pulses for measuring a distance to an obstacle, or object, situated in the sensing range of a sensor system.

In other implementations, use is made of AM (amplitude-modulated) signals, for instance a shaped pulse of a fixed-frequency carrier. AM signaling mode may enable the use of shorter bursts (e.g., on the order of 200 to 300 microseconds), reducing transmission time and increasing sensitivity to nearby obstacles. Other implementations may employ pulses with modulated carriers, e.g., modulated with binary phase shift keying (BPSK). For sake of clarity, the term “burst” as used herein refers to an AM (fixed frequency), BPSK (modulated), or chirp (swept frequency) pulse, which may be one of a series of bursts created by driving a piezoelectric element or other ultrasonic transducer. Chirp-modulated pulses may have a longer duration than a typical AM pulse, for instance more than 1 millisecond, such as in the range of 2-3 milliseconds. It is noted here that burst lengths can be varied, with shorter bursts being used to facilitate detection of nearby obstacles and longer bursts being used to increase burst energy (and echo energy) for more distant obstacles. Burst lengths for detecting nearby obstacles may be half or perhaps a quarter of the burst lengths used for more distant obstacles. The sensor may be switched between modes for different detection distances.

Although it is deemed particularly useful to systematically vary a characteristic frequency (e.g., the starting frequency or, equivalently, the center or ending frequency) of the chirp-modulated pulses in a series, such frequency variation can also be applied to the carrier frequency of the AM pulses in a series. The frequency variation can be expressed for each pulse as a frequency displacement from a nominal characteristic frequency (e.g., a nominal starting frequency or nominal carrier frequency).

To transmit an acoustic burst, the core logic configures the transmitter to drive the output pins for the ultrasonic transducer, which are coupled to a piezoelectric element PZ. A transformer M1 and/or resonance tuning network may be provided for voltage amplification and control of the transducer's resonant frequency. The transmitter may accept a carrier frequency signal from the oscillator with a nominal frequency of, e.g., 50 kHz. The transmitter may use the carrier frequency signal to generate a series of AM (amplitude modulated) or chirp pulses, each pulse corresponding to an acoustic burst. An example of a chirp pulse may be a pulse having a frequency swept upward from 7 kHz below the carrier frequency the carrier frequency, a low channel up-chirp. Another example may be a high channel up-chirp in which the chirp frequency is swept upward from the carrier frequency to 7 kHz above the carrier frequency. Down chirps may alternatively be employed, with the frequency being swept linearly downward rather than upward.

To receive an acoustic signal, the core logic configures the ADC 310 to digitize the electrical receive signal from the piezoelectric element PZ. The digitized signal may be provided directly to the DSP for real time processing or buffered in memory for later processing by the DSP. To reduce IO bandwidth requirements, the DSP may implement data compression to reduce the number of bits needed to represent the receive signal data or to represent the magnitude of the baseband signals. To further reduce bandwidth requirements, the DSP may optionally perform on-chip processing for peak detection and distance estimation. Various suitable processing techniques for detecting reflections of the acoustic burst are known in the art, including co-owned US Patent Publication 2024/0069192 “Motion-compensated distance sensing with concurrent up-chirp down-chirp waveforms”, which is hereby incorporated herein by reference.

As the received electrical signals are typically in the millivolt or microvolt range, the a receive amplifier 308 may be included to buffer and amplify the signal from the receive terminals. Analog or digital mixers may be included to down convert the receive signals to baseband for further filtering and processing by the DSP. The mixer is in one implementation an in-phase/quadrature (I/Q) digital mixer giving Zero Intermediate Frequency (ZIF) IQ data as its output. (Though the term “ZIF” is used herein, the down converted signal may in practice be a low intermediate frequency or “near-baseband” signal.) DSP 304 applies programmable methods to monitor the piezoelectric transducer during the transmission of a burst, and to detect any echoes and measure their parameters such as time-of-flight (ToF), duration, and peak amplitude. Such methods may employ threshold comparisons, minimum intervals, peak detections, zero-crossing detection and counting, noise level determinations, and other customizable techniques tailored for improving reliability and accuracy. Alternatively, the DSP may perform initial processing steps and convey the processed signal to the fusion processor for further analysis.

FIG. 4 is a block diagram of an illustrative signal processing path that may be embodied as firmware modules, i.e., instructions retrieved from memory for execution by the DSP. Alternatively, the modules may be implemented as application-specific integrated circuits, a field-programmable gate array (FPGA), or some other form of a programmable logic device (PLD).

A transmit control module 402 combines a waveform template from waveform control module 404 with a carrier signal from a digital carrier generation module 406 to form a digital burst signal. In at least some contemplated implementations, the digital burst signal is a linear frequency modulated chirp lasting about 2.5 milliseconds during which the frequency is swept upward from 7 kHz below the carrier frequency to 1 kHz below the carrier frequency (lower sideband up-chirp), or from 1 kHz above the carrier frequency to 7 kHz above the carrier frequency (upper sideband up-chirp). One or both of the up-chirps can be replaced by down-chirps in which the frequency is swept from the higher value to the lower value. The precise duration and frequency range can be customized, and some contemplated implementations divide the useful transducer frequency range into more than two channels, any one of which may be selected for the transmit control module 402 to employ.

A driver 408 converts the digital burst signal to a drive signal for piezoelectric transducer 410. The piezoelectric transducer 410 vibrates in response to the analog burst signal, thereby generating an acoustic burst signal that propagates outward from the transducer. Reflections of the acoustic burst vibrate the piezoelectric transducer, inducing a detectable analog receive signal. A receiver 412 amplifies and digitizes the analog receive signal, producing a digital receive signal. The sampling rate is at least twice the highest expected frequency component in the signal, and preferably more, e.g., an integer multiple such as 8×, which may enable efficient digital down conversion. Based on the digital receive signal, a gain controller 414 adjusts the gain of the driver 408 and/or the receiver 412 to optimize performance while preventing saturation of the receiver's analog to digital converter (ADC). A diagnostic module 416, alone or in combination with a reverberation monitor 418, analyzes the digital receive signal to detect and diagnose any transducer fault conditions. Some fault conditions may be indicated by, e.g., an excessively short reverberation periods (which may be due to a disconnected or defective transducer, suppressed vibration, or the like), while others may be indicated by an excessively long reverberation period (defective mounting, inadequate damping resistance, or the like). The diagnostic module 416 may detect and classify multiple such transducer fault conditions, storing the appropriate fault codes in internal registers or nonvolatile memory 305. Reverberation monitor 418 detects and signals the end of the transducer reverberation period. A wideband noise detector 419 monitors noise levels, operating outside the measurement period to detect potential interference with operation of the sensor array.

A mixer 420 combines the digital receive signal with the digital carrier signal to down convert the digital receive signal to a zero intermediate frequency (“ZIF”) representation having in-phase and quadrature signal components. A low pass filter 422 filters the ZIF signal components to exclude modulation byproducts that might otherwise cause aliasing. A magnitude module 424 optionally combines the in-phase and quadrature signal components to obtain a magnitude signal representing the magnitude of the receive signal. A “decimation” or down sampling module 426 reduces the sample rate of the low pass filtered ZIF signal components to reduce the computational burden of downstream components. In at least some contemplated implementations, the down sampling module 426 reduces the rate to approximately 20 kHz.

A correlator 428 filters the down-sampled ZIF signal components using correlation filters having impulse responses that match the waveform templates for each of the channels, e.g., up-chirps in the upper and lower sidebands. The correlation filters produce channel correlation signals in which the burst echoes are represented as peaks. In at least some implementations, the correlation filter output signals are converted from in-phase and quadrature-component representation to magnitude and phase representation to facilitate downstream processing. The correlation filters may use modified waveform templates (e.g., an up chirp combined with a Gaussian window function) to narrow the peaks in the correlation signals. In some cases, the correlation filters may vary their impulse responses as a function of time elapsed from the end of the reverberation period, enhancing detection performance at short distances while continuing to suppress channel crosstalk at medium or long distances. As one example, the applied window function can be varied to reduce the bandwidth of the chirp waveform as a function of elapsed time. At short distances, the larger bandwidth permits passage of partial echoes. Partial echoes are those whose initial portions arrive before the measurement start time, which corresponds to the end of transducer reverberation. This impulse response variation enables the correlation filters to provide peaks in the correlation signal for these partial echoes. As more time elapses, the partial echoes gradually become full echoes, and the bandwidth of each correlation filter is narrowed to provide better separation between the frequency channels. Interpolation can be used to determine the filter coefficients between the values initially used for correlating with partial echoes and the values used for correlating with full echoes.

However, it should be recognized that any correlation signal peaks associated with partial echoes are attenuated relative to peaks representing full echoes, not only because the partial echoes are shorter but also because their frequency content varies relative to the full echoes. Chirp attenuation control module 430 may scale the channel correlation signals based on the time elapsed since the measurement start time, applying a channel-dependent gain to compensate for partial echoes and associated frequency dependence of the transducer response, substantially enhancing short range detection performance. Module 430 may also apply a time dependent gain to compensate for echo attenuation due to propagation to and from the obstacles.

As described further below, a noise detection/suppression module 432 applies a nonlinear function to the attenuation-compensated channel correlation signals to suppress noise and amplify the peaks representing echoes. In some contemplated implementations, the module's output signals 433 are supplied a compressor 434 to reduce the number of bits needed to convey the correlation signals to the fusion processor for further processing. Other contemplated implementations include an echo detection module that detects the peaks in the channel correlation signals, determines the magnitude of the peaks, and calculates the time of flight (or equivalently, determines the distance) associated with each peak. Notably, the time-of-flight calculation accounts for the delay caused by the correlation filtering operation. Echo detection module may store the magnitude and time of flight information for the echoes detected in each channel in memory 305. Sensor interface module 436 conveys the desired information to the bus controller to be conveyed to the ECU.

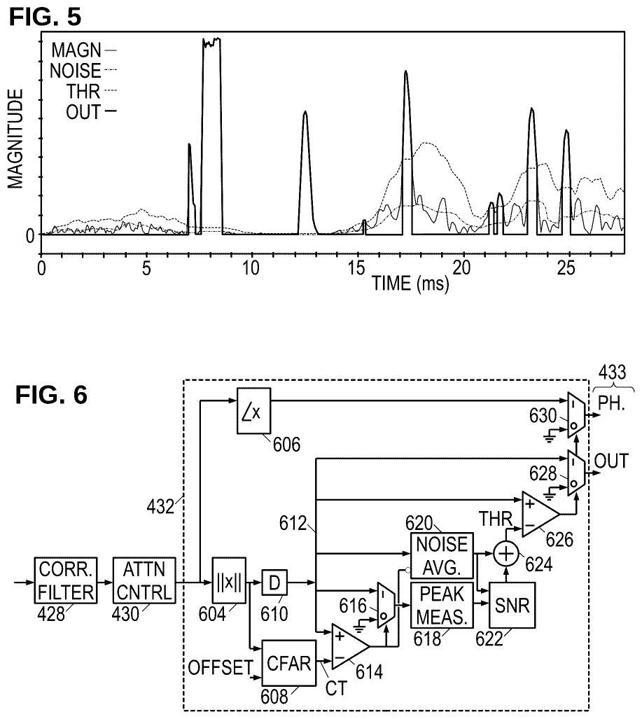

In practice, the response as received and digitized does not merely include any reflection from the ranging signal emitted by the acoustic transducer but also includes noise. Such noise originates from a variety of potential sources. FIG. 5 shows a thin solid line representing an illustrative correlation magnitude curve (“MAGN”). Also shown is a dash-dot line representing an average noise magnitude (“NOISE”) derived from the non-peak areas of the correlation magnitude curve as explained further below. A dashed line represents an illustrative threshold curve (“THR”) derived as explained in connection with FIG. 6. Finally, a thick solid line represents one of the output signals 433 (“OUT”) of the noise detection/suppression module 432. In the peak areas (where the magnitude curve exceeds the threshold curve), this output signal follows the magnitude curve. Outside of these peak areas, this output signal is zero.

FIG. 6 provides additional detail for an illustrative implementation of the noise detection/suppression module 432. The correlator 428 that convolves the downconverted signal with the waveform for the selected channel. Attenuation control 430 applies a time dependent gain to compensate for expected attenuation during the measurement period. A magnitude element 604 combines the in-phase and quadrature components of the signal to determine the signal magnitude. An arctangent module 606 may combine the in-phase and quadrature components to determine the phase of the correlation signal.

A CFAR element 608 operates on the correlation magnitude signal to provide a CFAR Threshold (CT) signal in accordance with a Constant False Alarm Rate (CFAR) algorithm. Various CFAR algorithms are described in the literature, including co-owned U.S. application Ser. No. 16/530,654, filed 2019 Aug. 2 and titled “Ultrasonic Sensor Having Edge-Based Echo Detection” by inventors M. Hustava and J. Kantor (citing U.S. Pat. No. 5,793,326 (“Hofele”)). Suitable CFAR algorithm variations include for instance CASH-CFAR (Cell Averaging Statistic Hofele CFAR) and Ordered Statistic-CFAR (OS-CFAR). Briefly stated, the CFAR algorithms perform statistical processing within a moving window to determine a threshold value representing background “clutter”, the processing operating to exclude from the threshold determination any strong peaks that would likely represent a valid echo. The CFAR variations vary in the precise nature of the statistical processing, e.g., whether using a min-max-sum, rank ordering, or averaging operations in combination with suitable weighting or scaling to enable adequate distinguishing between valid echoes and background noise. Various parameters of the algorithm (e.g., block size, window size) can be adjusted to optimize the adaptiveness of the threshold. A CFAR offset value may be stored in a memory and added to the algorithm-based threshold value to provide further tuning of the CT signal.

The CFAR element 608 may operate on a symmetric or asymmetric window around a “current” sample of the correlation magnitude signal. A delay element 610 may accordingly be used to provide a suitable time offset between the “early” correlation magnitude signal supplied to the CFAR element 608 and the “current” correlation magnitude signal 612 supplied to the other elements of the processing circuit. A comparator 614 compares the current correlation magnitude signal 612 to the CFAR threshold signal CT, asserting a selection signal for multiplexer 616 to indicate when the correlation magnitude signal is above the threshold (a “peak area”), and de-asserting the selection signal to indicate when the correlation magnitude signal is below the threshold (a “non-peak area”).

A noise averaging block 620 receives the selection signal at an inverted enable (/EN) input, also known as a disable input, that disables operation of the noise averaging block 620 while the comparator output is asserted. In this fashion, averaging block 620 operates on the non-peak areas of the signal and ignores the peak areas of the correlation magnitude signal when determining the average noise magnitude (“NOISE” in FIG. 5). Noise averaging block 620 calculates an average within a given portion or moving window of the non-peak correlation magnitude signal. The averaging block may for instance be configured to sum signals of the non-peak areas in the signal portion and divide it by the duration of the non-peak areas of the signal portion. While the present application refers to an average, it is to be understood that the resulting average may be any type of average as known to the person skilled in the art, including the median, the arithmetic average (mean), the mode, the geometric mean and/or a weighted average, and exponential rolling average.

For each peak area in the current correlation magnitude signal, a peak measurement element 618 determines the signal strength by identifying the peak value (local maximum). A signal-to-noise ratio (SNR) block 622 accepts each peak value from peak measurement element 618 and uses a corresponding noise average value from noise averaging block to calculate a SNR value for that peak. We note here that block 622 is not limited to any definitional formula such as SNR=20 log₁₀(signal/noise). In fact, given the hardware complexity typically associated with a logarithmic calculation, it may be preferred to use a simple ratio or other calculation that monotonically relates to the definitional formula in the region of interest. The SNR block 622 generates a peak detection threshold that is inversely related to the SNR value. The peak detection threshold may be low in regions where the SNR is relatively high, and may be relatively high in regions where the SNR is low. The SNR block 622 may employ a lookup table to convert the SNR value to a peak detection threshold.

A summation element 624 adds the peak detection threshold to the average noise level to determine the threshold curve THR of FIG. 5. A comparator 626 compares the current correlation magnitude signal 612 to the threshold value THR, asserting a selection signal only when the signal magnitude exceeds the threshold. In response to the selection signal, multiplexer 628 selects the current correlation magnitude signal 612 when the selection signal is asserted, and selects a zero signal to suppress the output signal OUT when the selection signal is de-asserted. Another multiplexer 630 may also respond to the selection signal, outputting the correlation signal phase when the selection signal is asserted and suppressing the phase output when the selection signal is de-asserted.

With the foregoing context, we now turn to the operation of compressor 434. In certain contemplated implementations, the compressor down samples the correlation magnitude signal, e.g., dropping every second sample, before scaling and quantizing to a lower bit resolution. The compressor may treat the correlation magnitude signal as a series of signal segments each having a predetermined number of samples. A scale factor is determined for each segment, which (unless it maxes out) normalizes the peak value in that segment to unity. As one example, the scale factor may have a five-bit representation. In some cases, the scale factor uses a nonlinear scale. The compressor then quantizes the scaled sample values with a reduced bit resolution. As one specific example, the compressor may use a three-bit resolution for each of the samples in the segment.

Given the scale factor and quantized samples for each segment, the fusion processor can re-scale and interpolate the data to reconstruct the correlation magnitude signal with sufficient fidelity to detect and monitor reflectors within the measurement zone of the ultrasonic sensor arrays. However, with increasingly sophisticated processing, system designers desire the ability to better distinguish closely spaced peaks and/or the ability to detect marginal signal energy around a main peak which may reveal additional information useful for distinguishing different types of object, e.g., a person as contrasted with a curb. The compressor 434 may accordingly adapt the encoding parameters associated with selected segments of the correlation magnitude signal.

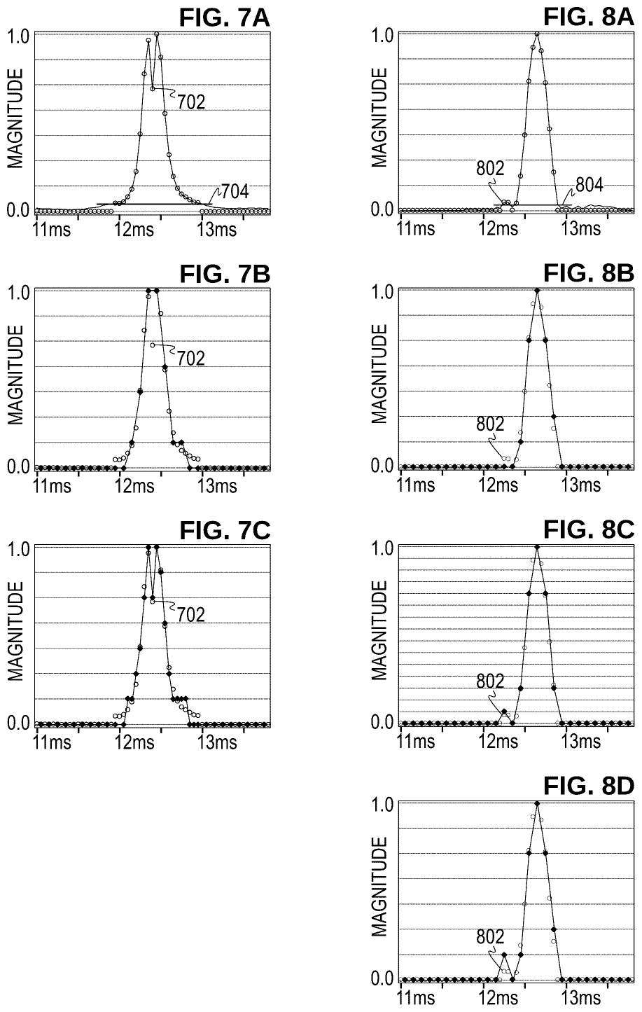

FIG. 7A shows an illustrative output signal prior to the compression process. (For convenience, it is assumed that the samples in the illustrated output signal segment have been scaled so the peak value is unity.) Correlation magnitude signal samples are represented by open circles. The samples outside the peak area (i.e., below the noise threshold 704) have been forced to zero. Within the peak area, sample 702 indicates a dip that may distinguish two closely spaced peaks. The dip is typically associated with a substantial shift in the signal phase, but can also be detected as a significant interpolation error. In FIG. 7B, for example, the black diamonds represent the down sampled and quantized samples. The solid line is a linear interpolation between these compressed samples, and it may be noted that sample 702 deviates from the line by over two quantization steps. (Linear interpolation is used for ease of illustration, but any suitable interpolation method may be used including, e.g., cosine interpolation, cubic interpolation, Hermite interpolation.) The threshold for detecting excessive interpolation error is preferably at least half a quantization step, but may be customized to optimize system performance.

Upon detecting the interpolation error, or alternatively, upon detecting a phase shift exceeding a predetermined threshold (e.g. 30 degrees), the compressor 434 may reduce the down sampling rate from, e.g., 2:1 to 1:1. FIG. 7C shows the compressed representation with the reduced sampling rate. Note that the maximum interpolation error has dropped to about half a quantization step. As an alternative, the compressor may maintain the down sampling rate but change the signal type, sending correlation signal magnitude and phase (or in-phase and quadrature phase components) rather than the correlation magnitude signal alone. The additional information is expected to substantially eliminate or at least reduce the interpolation error.

FIG. 8A shows another illustrative output signal prior to the compression process. Note the presence of a sample 802 representing a marginal signal, i.e., a signal that is above the noise threshold 804 but having a small magnitude after the peak normalization of its output signal segment. When the sample has a magnitude below the lowest quantization threshold, usually equal to half a quantization step, the quantization process suppresses the marginal signal as shown in FIG. 8B. If the compressor 434 detects such a circumstance, it may adapt the bit resolution used for quantizing the samples within the given signal segment, e.g., increasing the bit resolution from 3 bits to 4 bits. FIG. 8C shows an example of compressed samples using increased bit resolution.

Alternatively, the compressor 434 may maintain the bit resolution and instead adapt the lowest quantization threshold for the signal segment, e.g., lowering the threshold from half a quantization step to the noise threshold, such that any sample having a magnitude above the noise threshold is quantized to a nonzero value. FIG. 8D shows an example of the compressed samples obtained with this approach.

When such adaptation of the encoding parameters is performed, the compressor 434 may provide a field to indicate the current value of the given parameter for each segment. It is expected, however, that the described instances will tend to occur in the short measurement range, and at longer ranges it is expected that attenuation will make such effects uncommon or at least undetectable. Accordingly, the compressor may be configured to adapt the encoding parameters as a function of elapsed time within the measurement intervals following each acoustic burst. As an example, the compressor may employ one set of parameters (signal type, down sampling rate, bit resolution, lowest quantization threshold) for the first 12 milliseconds of the measurement interval, then employ a second set of parameter for the remainder of the measurement interval. The signal type may progress from correlation magnitude and phase to just correlation magnitude and the bit resolution may decrease from 4 bits to 3 bits. As another example, the down sampling rate may increase from 1:1 to 2:1 as the lowest quantization threshold is adjusted from a quarter of a quantization step to a half of a quantization step while the remaining parameters are held constant. Or the down sampling rate and bit resolution may be adjusted while the other parameters are maintained. Of course, any individual parameter may also be adjusted independently from the others.

In at least some contemplated implementations, a portion of the measurement interval is dedicated to noise monitoring. For example, during the final millisecond of the measurement period, which immediately precedes a subsequent acoustic burst, the correlation magnitude signal may be analyzed by the fusion processor to estimate an ambient noise level. The noise detection/suppression module may be disabled during this period, enabling the compressor 434 to operate on the “raw” correlation magnitude data. The encoding parameters employed by the compressor may be selected to minimize added distortion, e.g., the down sampling rate may be minimized (set to 1:1), the bit resolution may be maximized (e.g., set to 4-bits), and/or the signal type may set to convey the complex-valued correlation signal (in-phase and quadrature components, or magnitude and phase) rather than the magnitude alone.

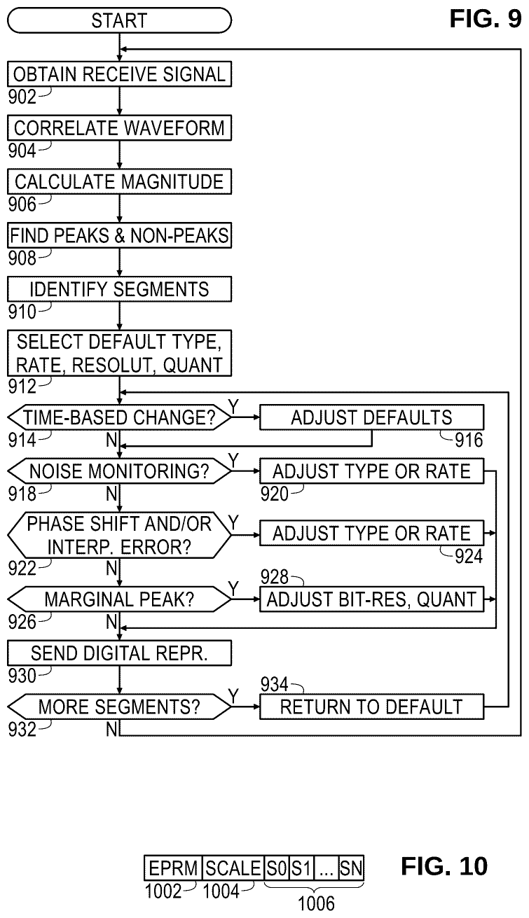

FIG. 9 is a flow diagram of an illustrative sensing method employing adaptive compression. The various operations may be implemented by the above-described sensor controller. In block 902, the sensor controller obtains a receive signal from an ultrasonic transducer. The receiving operation may immediately follow an acoustic burst transmission by the same transducer or by another transducer in the sensor array. The receiving operation may include digitation, downmixing, and filtering to obtain a baseband digital receive signal. Down sampling may be optionally performed to reduce processing loads on subsequent components in the chain. In block 904, the controller filters the digital receive signal with one or more correlation filters to obtain a correlation signal for each channel. The correlation filter output may be complex valued, i.e., having in-phase and quadrature-phase components, and accordingly the controller may calculate the correlation magnitude signal in block 906. Optionally a correlation phase signal may also be determined in this block.

In block 908, the controller analyzes the correlation magnitude signal to distinguish peak areas from non-peak areas, suppressing the noise in the latter. In block 910, the controller divides the correlation magnitude signal into segments in preparation for compression. The default encoding parameters are set to their initial values in block 912. The controller may then work its was through the segments in order, iterating through blocks 914-934 as it progresses.

In block 914, the controller determines whether the current segment is associated with an elapsed-time based change to the encoding parameters, and if so, adjusts the parameter values to new defaults. For example, the default signal type may initially be output signal value (expressible in terms of magnitude and phase), and may switch to solely output signal magnitude after 13 milliseconds. As another example, the default bit resolution may initially be four bits and may switch to three-bit resolution after 9 milliseconds. In block 918, the controller determines whether the current segment corresponds to a noise monitoring interval. If so, the controller adjusts the signal type and/or decimation rate in block 920 before progressing to block 930. Otherwise, in block 922, the controller determines whether the current segment has a phase shift in excess of a predetermined threshold. Alternatively, the controller determines whether the current segment will have an excessive interpolation error with the default encoding parameter values. If so, then in block 924 the controller switches or varies the encoding parameter values accordingly before progressing to block 930. Otherwise, in block 926 the controller determines whether the current segment contains a marginal signal that would be suppressed with the default encoding parameters. If so, the controller adjusts the bit resolution and/or lowest quantization threshold in block 928.

In block 930, the controller uses the selected encoding parameter values to form a compressed digital representation of the current segment, which is then conveyed to the fusion processor via the bus controller. In block 932 the controller determines whether the measurement period has more segments, and if so, returns the encoding parameters to their default values in block 934 before returning to block 914 to process the next segment. Once the measurement period is fully processed, the controller returns to block 902.

Though the operations shown and described above are treated as being sequential for explanatory purposes, in practice the process may be carried out by multiple integrated circuit components operating concurrently (and perhaps even speculatively) to enable operations to be performed in parallel or out-of-order. These and numerous other modifications, equivalents, and alternatives, will become apparent to those skilled in the art once the above disclosure is fully appreciated. It is intended that the following claims be interpreted to embrace all such modifications, equivalents, and alternatives where applicable.

FIG. 10 shows an example of a digital representation of an output signal segment that may be generated by the compressor 434. The illustrative digital representation is a word having, e.g., 32 bits. An encoding parameter 1002 may be indicated by a first bit which indicates, e.g., whether a first or second value is being used for the signal type, the decimation rate, the bit resolution, or the lowest quantization threshold. If the change in the encoding parameter value switches automatically based solely on elapsed time, this field may be omitted. The illustrated representation includes a field for a scale value 1004, which indicates the scale factor used to normalize the peak value to unity. This field may have, e.g., five bits. The illustrated representation further includes fields for a predetermined number of output signal sample values 1006. These fields may be, e.g., three or four bits each.

While dependent claims are written down to refer back to a single claim as a matter of claim drafting prescriptions in certain countries, it is observed that any combination of a dependent claim with any of its preceding claims is foreseen by the present inventors and is deemed included in the full disclosure of the present application. Furthermore, it is to be understood that the dependent claims specified for one claim category apply also to another claim category but have merely been omitted for the sake of limiting the overall number of claims and any claim fees that may be due as a result thereof.

While the driver-assist system context is used as an example herein, the concepts of this disclosure may be applied to any type of obstacle monitoring or distance measurement systems and may be particularly suitable for those that prioritize reliability and rapid response.

What is claimed is:

1. A sensor that comprises:
a piezoelectric transducer; and
a sensor controller that includes:
a receiver coupled to an ultrasonic transducer to obtain a receive signal having one or more reflections of an acoustic burst within a measurement interval associated with the acoustic burst;
a correlator configured to produce an output signal having a peak for each of the one or more reflections; and
a compressor configured to determine a digital representation of the output signal for communication via a bus using at least one encoding parameter that varies within the measurement interval.

2. The sensor of claim 1, wherein the at least one encoding parameter is one of: a signal decimation rate, a bit resolution, a quantization threshold, and a signal type, wherein the signal type is selectable from a set that includes at least:
output signal magnitude; and
output signal value expressed in terms of in-phase and quadrature components or in terms of magnitude and phase.

3. The sensor of claim 2, wherein the at least one encoding parameter varies based on elapsed time within the measurement interval.

4. The sensor of claim 3, wherein the at least one encoding parameter is the signal decimation rate, and wherein the signal decimation rate increases during the measurement interval.

5. The sensor of claim 3, wherein the at least one encoding parameter is the bit resolution, and wherein the bit resolution decreases during the measurement interval.

6. The sensor of claim 3, wherein the at least one encoding parameter is the signal type, and wherein the signal type is initially the output signal value and switches to output signal magnitude during the measurement interval.

7. The sensor of claim 2, wherein the compressor identifies an output signal segment for each of said peaks, and wherein the at least one encoding parameter varies based on content of the output signal segment.

8. The sensor of claim 7, wherein the at least one encoding parameter is a higher signal decimation rate by default, and wherein the at least one encoding parameter changes to a lower signal decimation rate when the output signal segment includes a phase shift or an interpolation error above a predetermined threshold.

9. The sensor of claim 7, wherein the at least one encoding parameter is the signal type, wherein a default signal type is the output signal magnitude, and wherein the at least one encoding parameter changes to output signal value when the output signal segment includes a phase shift or an interpolation error above a predetermined threshold.

10. The sensor of claim 7, wherein the at least one encoding parameter is a lower bit resolution by default, and wherein the at least one encoding parameter changes to a higher bit resolution when the output signal segment includes a marginal signal below a lowest quantization threshold.

11. The sensor of claim 7, wherein the at least one encoding parameter is a standard lowest quantization threshold by default, and wherein the at least one encoding parameter changes to a noise threshold when the output signal segment includes a marginal signal below the standard lowest quantization threshold.

12. The sensor of claim 1, wherein the measurement interval includes at least a noise monitoring period and an echo detection period, wherein the at least one encoding parameter is a signal decimation rate that switches between 1:1 during the noise monitoring period and at least 2:1 for at least part of the echo detection period.

13. A method that comprises:
obtaining a receive signal having one or more reflections of an acoustic burst within a measurement interval associated with the acoustic burst;
applying a correlation filter to produce an output signal having a peak for each of the one or more reflections; and
determining a digital representation of the output signal using at least one encoding parameter that varies within the measurement interval.

14. The method of claim 13, wherein the at least one encoding parameter is one of: a signal decimation rate, a bit resolution, a quantization threshold, and a signal type, wherein the signal type is selectable from a set that includes at least:
output signal magnitude; and
output signal value expressed in terms of in-phase and quadrature components or in terms of magnitude and phase.

15. The method of claim 14, wherein the at least one encoding parameter varies based on elapsed time within the measurement interval.

16. The method of claim 15, wherein the at least one encoding parameter is the signal decimation rate, and wherein the signal decimation rate increases during the measurement interval.

17. The method of claim 15, wherein the at least one encoding parameter is the bit resolution, and wherein the bit resolution decreases during the measurement interval.

18. The method of claim 15, wherein the at least one encoding parameter is the signal type, and wherein the signal type is initially the output signal value and switches to output signal magnitude during the measurement interval.

19. The method of claim 14, wherein said determining includes identifying an output signal segment for each of said peaks, and wherein the at least one encoding parameter varies based on content of the output signal segment.

20. The method of claim 19, wherein the at least one encoding parameter is a higher signal decimation rate by default, and wherein the at least one encoding parameter changes to a lower signal decimation rate when the output signal segment includes a phase shift or an interpolation error above a predetermined threshold.

21. The method of claim 19, wherein the at least one encoding parameter is the signal type, wherein a default signal type is the output signal magnitude, and wherein the at least one encoding parameter changes to output signal value when the output signal segment includes a phase shift or an interpolation error above a predetermined threshold.

22. The method of claim 19, wherein the at least one encoding parameter is a lower bit resolution by default, and wherein the at least one encoding parameter changes to a higher bit resolution when the output signal segment includes a marginal signal below a lowest quantization threshold.

23. The method of claim 19, wherein the at least one encoding parameter is a standard lowest quantization threshold by default, and wherein the at least one encoding parameter changes to a noise threshold when the output signal segment includes a marginal signal below the standard lowest quantization threshold.

24. The method of claim 13, wherein the measurement interval includes at least a noise monitoring period and an echo detection period, wherein the at least one encoding parameter is a signal decimation rate that switches between 1:1 during the noise monitoring period and at least 2:1 for at least part of the echo detection period.

25. A sensor controller that comprises:
a receiver coupled to an ultrasonic transducer to obtain a receive signal having one or more reflections of an acoustic burst within a measurement interval associated with the acoustic burst;
a correlator configured to produce an output signal having a peak for each of the one or more reflections; and
a compressor configured to determine a digital representation of the output signal for communication via a bus using at least one encoding parameter that varies within the measurement interval.

26. The sensor controller of claim 25, wherein the at least one encoding parameter is a signal decimation rate that varies based on elapsed time within the measurement interval.

27. The sensor controller of claim 25, wherein the at least one encoding parameter is a bit resolution that varies based on elapsed time within the measurement interval.

28. The sensor controller of claim 25, wherein the at least one encoding parameter is a signal type that is initially an output signal value expressed in terms of in-phase and quadrature components or in terms of magnitude and phase, and wherein the signal type switches to an output signal magnitude based on elapsed time within the measurement interval.

29. The sensor controller of claim 25, wherein the compressor identifies an output signal segment for each of said peaks, and wherein the at least one encoding parameter varies based on content of the output signal segment.

30. The sensor controller of claim 29, wherein the at least one encoding parameter is a higher signal decimation rate by default, and wherein the at least one encoding parameter changes to a lower signal decimation rate when the output signal segment includes a phase shift or an interpolation error above a predetermined threshold.

31. The sensor controller of claim 29, wherein the at least one encoding parameter is a signal type that is an output signal magnitude by default, and wherein the at least one encoding parameter changes to an output signal value expressed in terms of in-phase and quadrature components or in terms of magnitude and phase when the output signal segment includes a phase shift or an interpolation error above a predetermined threshold.

32. The sensor controller of claim 29, wherein the at least one encoding parameter is a lower bit resolution by default, and wherein the at least one encoding parameter changes to a higher bit resolution when the output signal segment includes a marginal signal below a lowest quantization threshold.

33. The sensor controller of claim 29, wherein the at least one encoding parameter is a standard lowest quantization threshold by default, and wherein the at least one encoding parameter changes to a noise threshold when the output signal segment includes a marginal signal below the standard lowest quantization threshold.

34. The sensor controller of claim 25, wherein the measurement interval includes at least a noise monitoring period and an echo detection period, wherein the at least one encoding parameter is a signal decimation rate that switches between 1:1 during the noise monitoring period and at least 2:1 for at least part of the echo detection period.
